(19) United States
(12) Patent Application Publication
(10) Pub. No.: US 2009/0025807 A1
(43) Pub. Date: Jan. 29, 2009

(54) RUBEE ENABLED OUTDOOR FAUCET AND WATERING CONTROL SYSTEM

(75) Inventors: Jason August, Toronto (CA); John Stevens, Stratham, NH (US); Paul Waterhouse, Copetown (CA)

Correspondence Address: MICHAEL J. BUCHENHORNER, 8540 S.W. 83 STREET, MIAMI, FL, 33143, US

(73) Assignee: Visible Assets Inc., Mississauga (CA)

(21) Appl. No.: 12/171,025

(22) Filed: Jul. 10, 2008

Related U.S. Application Data
(60) Provisional application No. 60/948,967, filed on Jul. 10, 2007.

(51) Int. Cl. F17D 3/00

(52) U.S. Cl. 137/624.11

(57) ABSTRACT

A control system for an outdoor faucet includes a control unit encased in a waterproof housing. Inside the waterproof housing can be found an omni-directional antenna; a transceiver operatively coupled with the antenna and operating at a low radio frequency below 300 kHz; an onboard memory for storing data; a motor valve for controlling liquid flow; a micro controller unit operatively coupled with the onboard memory and configured for controlling operation of the control unit and for actuating the motor valve; and a connector for coupling with an energy source for powering the control unit.

### CROSS-REFERENCE TO RELATED APPLICATIONS

This application is a non-provisional of, and claims priority from, U.S. Patent Application Ser. No. 60/948,967, filed on Jul. 10, 2007, which is incorporated by reference as if fully set forth herein.

### TRADEMARKS

RuBee® is a registered trademark of Visible Assets, Inc. of the United States. Other names used herein may be registered trademarks, trademarks or product names of Visible Assets, Inc. or other companies.

### FIELD OF THE INVENTION

The invention disclosed broadly relates to the field of faucet control systems and more particularly relates to the field of RuBee® enabled faucet control systems.

### BACKGROUND OF THE INVENTION

Water management and conservation are important issues today. Many businesses and homeowners are taking an interest in this environmental issue, especially in areas affected by drought and falling water tables. In these areas, local governmental agencies have taken action by imposing water restrictions. These restrictions often take the form of restricting the number of days a week and/or the hours that a lawn can be watered. Homeowners and business owners can be fined for watering their lawns on the wrong day or at the wrong time of day.

This situation has popularized the use of faucet control systems which have been around for many years. See U.S. Pat. No. 5,505,227 “Faucet Control Device,” filed Aug. 30, 1994 by Peter Pubben.

Known systems for outdoor use such as in lawns and commercial nurseries are limited in that they must be either manually set or reset, or require wiring. Outdoor water faucets (see FIG. 1) are often programmed to control on/off watering times. They have timers that are mechanically simple and use low cost, low power microcontrollers. The user interface for the user to program the unit, however, substantially drives up the cost. A typical unit might contain a 150 to 200 segment liquid crystal display (LCD) with several buttons. The buttons tend to be rubber and sealed so water cannot penetrate the unit. The user interface (UI) and the UI programming is often complex and expensive if many faucet valves are involved. This problem has been addressed with the introduction of a central programming unit with wires connecting the individual faucet valves. This has the advantage of placing the higher cost of the UI on just one single unit which helps distribute the cost over many faucets. The disadvantage here is that the reach of the faucets is limited by the wiring.

See FIG. 2 for an example of a faucet control system using wires. The system as shown in FIG. 2 has four channels, therefore it has a maximum capacity of four faucet connections. This system is also limited in distance by wire length; therefore it is not adequate for use in commercial nurseries or wide expanses such as golf courses.

### SUMMARY OF THE INVENTION

Briefly, according to an embodiment of the present invention, a control system for an outdoor faucet includes a control unit encased in a waterproof housing. Inside the waterproof housing can be found an omni-directional antenna; a transceiver operatively coupled with the antenna and operating at a low radio frequency below 300 kHz; an onboard memory for storing data; a motor valve for controlling liquid flow; a micro controller unit operatively coupled with the onboard memory and configured for controlling operation of the control unit and for actuating the motor valve; and a connector for coupling with an energy source for powering the control unit.

The control system may further include a liquid inlet and a liquid outlet for guiding liquid flow through the control unit wherein the liquid flow is controlled by the motor valve. In a preferred embodiment of the invention the liquid is water.

A separate program unit includes program code for monitoring the control unit and a transceiver operable at the same low radio frequency as the control unit transceiver for wireless transmission of the program code to the control unit. In a preferred embodiment, the program unit is embodied as a portable handheld device and includes a display screen. The program unit is configured to wirelessly interact with more than one control unit.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 shows a conventional watering unit with a control unit and a program unit, according to the known art;

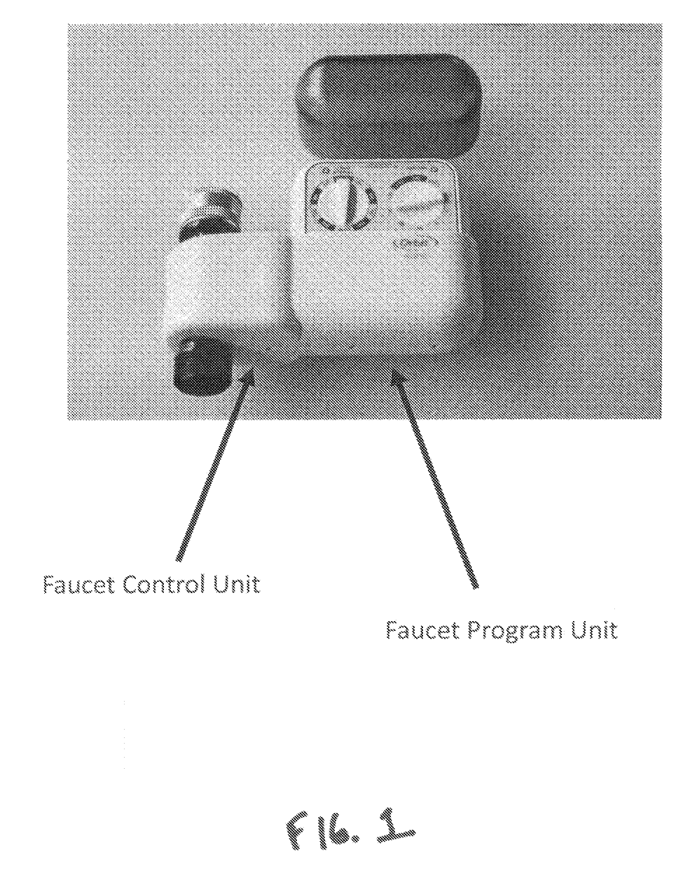

FIG. 2 shows the program unit and control unit attached by a wire, according to the known art;

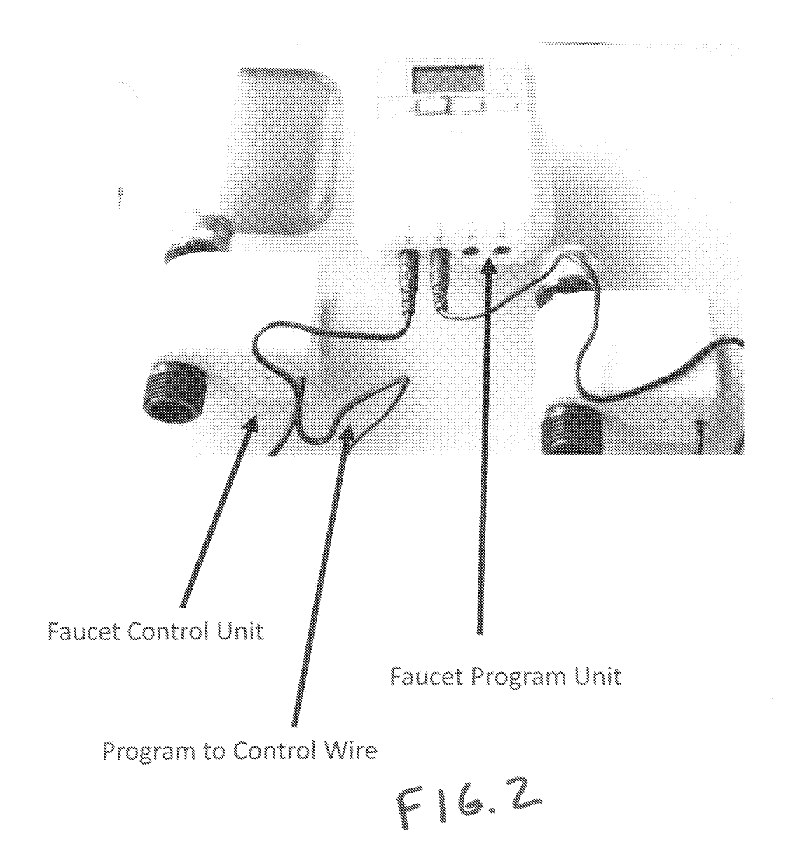

FIG. 3 shows a RuBee® enabled water control unit and RuBee® enabled handheld program unit, according to an embodiment of the present invention;

FIG. 4 is a simplified block diagram of a RuBee® enabled control unit, according to an embodiment of the present invention;

FIG. 5 shows a program unit, according to another embodiment of the present invention; and

FIG. 6 shows a control unit optionally programmed by a RuBee® enabled laptop, according to another embodiment of the present invention.

While the invention can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

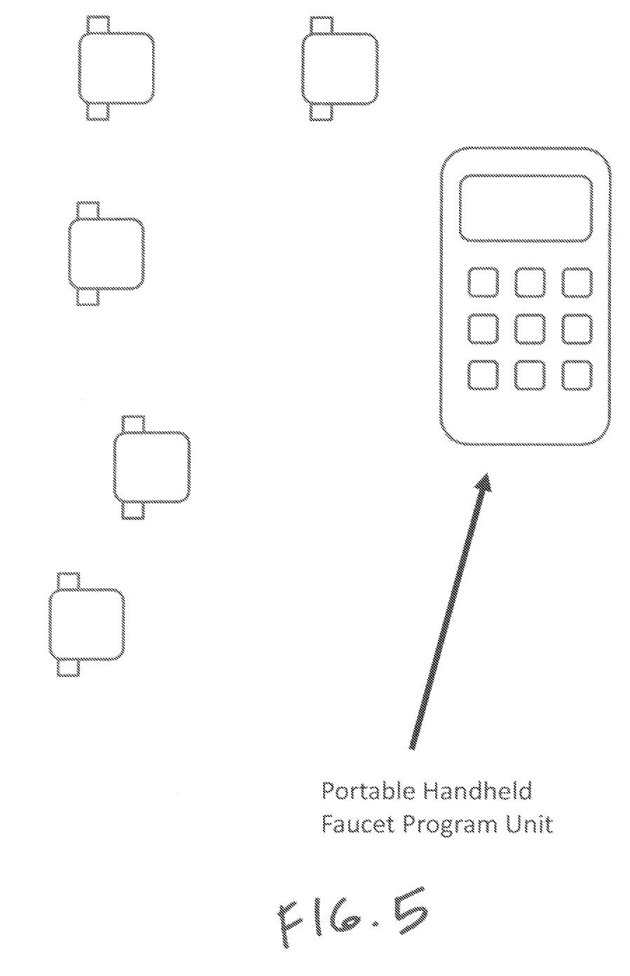

We disclose the use of a long wavelength low frequency system known as RuBee® to replace the wiring currently used in faucet control systems. A RuBee® based system has no limitations on number of units and the units can be placed anywhere because no wiring is necessary. A simple handheld unit can program an individual unit from about one to three feet away from the control unit, as shown in FIG. 5. This makes the RuBee® faucet control system ideal for use in large landscaped areas such as golf courses and in commercial nurseries.

The RuBee® faucet control system uses low frequency radio signals. This is critical because higher frequencies are affected by water and have a short battery life. RuBee®, however, is unique in that it has a long battery life and is not affected by water. Thus, the RuBee® faucet controller can have a battery and a RuBee™ wireless link without any display or buttons. This reduces the controller costs and makes it far more watertight and compact. A single programming unit may be used to program read and write status to each controller while it is connected to the water source. This unit may be a RuBee® enabled personal digital assistant (PDA) or iPod or other device as well with the appropriate software.

The individual units may also be programmed and set up via a laptop or other computing device enabled with a RuBee® interface and the appropriate software. Once programmed, the individual unit may be attached to the water source and area and will function based on the simple program loaded into its memory.

Before discussing the configuration of the RuBee® faucet controller, we first provide a background on the RuBee® technology used in the controller.

RuBee® Tag Technology.

Radio tags communicate via magnetic (inductive communication) or electric radio communication to a base station or reader, or to another radio tag. A RuBee® radio tag works through water and other bodily fluids, and near steel, with an eight to fifteen foot range, a five to ten-year battery life, and three million reads/writes. It operates at 132 KHz and is a full on-demand peer-to-peer, radiating transceiver.

RuBee® is a bidirectional, on-demand, peer-to-peer transceiver protocol operating at wavelengths below 450 KHz (low frequency). A transceiver is a radiating radio tag that actively receives digital data and actively transmits data by providing power to an antenna. A transceiver may be active or passive. The RuBee® standard is documented in the IEEE Standards body as IEEE P1902.1.

Low frequency (LF), active radiating transceiver tags are especially useful for visibility and for tracking both inanimate and animate objects with large area loop antennas over other more expensive active radiating transponder high frequency (HF)/ultra high frequency (UHF) tags. These LF tags function well in harsh environments, near water and steel, and may have full two-way digital communications protocol, digital static memory and optional processing ability, sensors with memory, and ranges of up to 100 feet. The active radiating transceiver tags can be far less costly than other active transceiver tags (many under one US dollar), and often less costly than passive back-scattered transponder RFID tags, especially those that require memory and make use of an EEPROM. With an optional on-board crystal, these low frequency radiating transceiver tags also provide a high level of security by providing a date-time stamp, making full AES (Advanced Encryption Standard) encryption and one-time pad ciphers possible.

One of the advantages of the RuBee® tags is that they can receive and transmit well through water and near steel. This is because RuBee® operates at a low frequency. Low frequency radio tags are immune to nulls often found near steel and liquids, as in high frequency and ultra high-frequency tags. This makes them ideally suited for use with firearms made of steel. Fluids have also posed significant problems for current tags. The RuBee® tag works well through water. In fact, tests have shown that the RuBee® tags work well even when fully submerged in water. This is not true for any frequency above 1 MHz. Radio signals in the 13.56 MHz range have losses of over 50% in signal strength as a result of water, and anything over 30 MHz have losses of 99%.

Another advantage is that RuBee® tags can be networked. One tag is operable to send and receive radio signals from another tag within the network or to a reader. The reader itself is operable to receive signals from all of the tags within the network. These networks operate at long-wavelengths and accommodate low-cost radio tags at ranges to 100 feet. The standard, IEEE P1902.1, “RuBee Standard for Long Wavelength Network Protocol”, allows for networks encompassing thousands of radio tags operating below 450 KHz.

The inductive mode of the RuBee® tag uses low frequencies, 3-30 kHz VLF or the Myriametric frequency range, 30-300 kHz LF in the Kilometric range, with some in the 300-3000 kHz MF or Hectometric range (usually under 450 kHz). Since the wavelength is so long at these low frequencies, over 99% of the radiated energy is magnetic, as opposed to a radiated electric field. Because most of the energy is magnetic, antennas are significantly (10 to 1000 times) smaller than ¼ wavelength or 1/10 wavelength, which would be required to efficiently radiate an electrical field. This is the preferred mode.

As opposed to the inductive mode radiation above, the electromagnetic mode uses frequencies above 3000 kHz in the Hectometric range, typically 8-900 MHz, where the majority of the radiated energy generated or detected may come from the electric field, and a ¼ or 1/10 wavelength antenna or design is often possible and utilized. The majority of radiated and detected energy is an electric field.

RuBee® tags are also programmable, unlike RFID tags. The RuBee® tags may be programmed with additional data and processing capabilities to allow them to respond to sensor-detected events and to other tags within a network.

Rubee®-Configured Faucet Control.

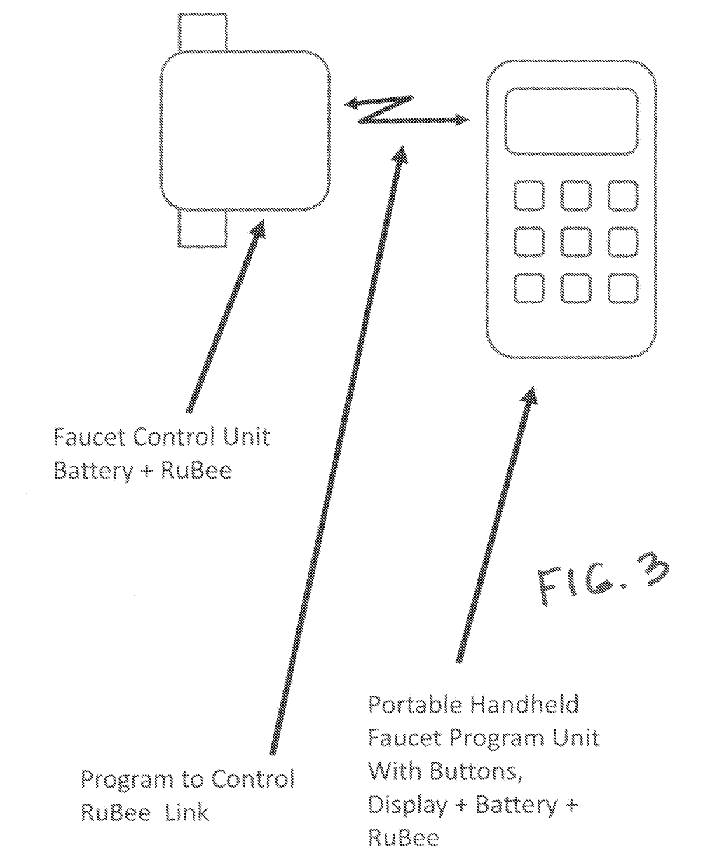

Referring now in specific detail to the drawings, and particularly FIG. 3, there is illustrated an exemplary faucet control system according to an embodiment of the present invention. The system of FIG. 3 shows an exemplary faucet control unit equipped with a battery and a RuBee® transceiver tag. Also shown is a portable handheld unit which is one option of programming and monitoring the control unit. The two devices communicate with each other via a long wavelength packet-based signal. This long wavelength signal is not affected by water and only minimally affected by steel. In fact, steel can be tuned to the unit's benefit.

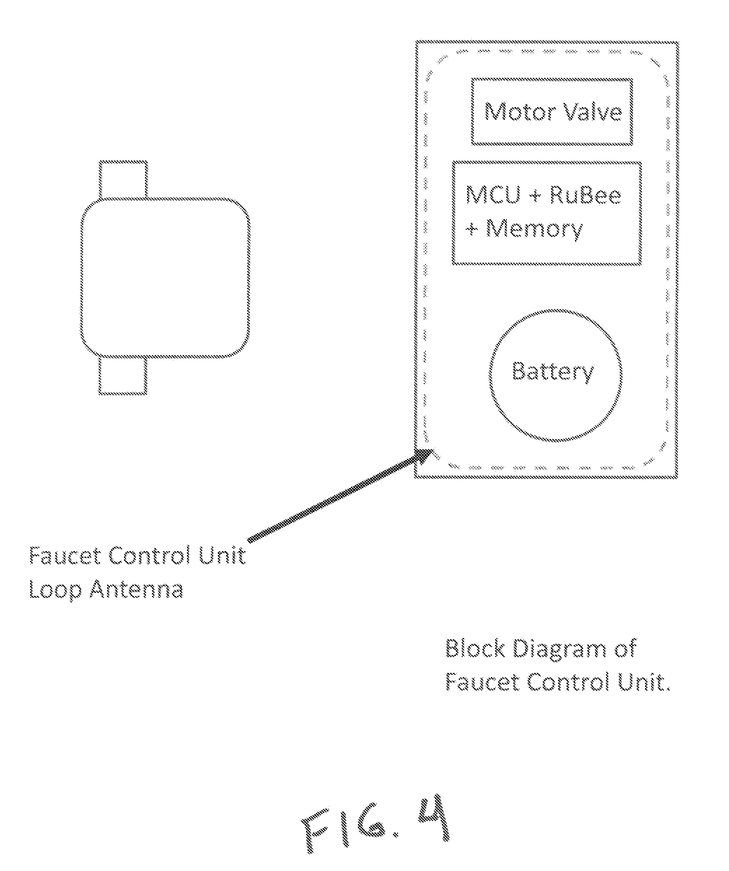

Referring to FIG. 4 there is shown an illustration of the components of the control unit. The control unit includes the following components:

Device antenna. The antenna is a small omni-directional loop antenna with an approximate range of eight to fifteen feet. It is preferably a thin wire wrapped many times around the inside edge of the control unit housing. A reader or monitor may be placed anywhere within that range in order to read signals transmitted from the control unit. One example of a reader is the handheld unit as shown in FIG. 3.

Motor Valve. This is a standard motor valve commonly used in current faucet control systems. In this system, the motor valve is controlled by the micro controller unit (MCU).

RuBee® transceiver. The transceiver is operatively connected to the antenna 260. It may be created on a custom integrated circuit using four micron CMOS (complementary metal-oxide semiconductor) technology. This custom transceiver is designed to communicate (transmit and receive radio signals) through the omni-directional loop antenna. All communications take place at very low frequencies (e.g. under 300 kHz). By using very low frequencies the range of the control unit is somewhat limited; however power consumption is also greatly reduced. Thus, the receiver may be on at all times and hundreds of thousands of communication transactions can take place, while maintaining a life of many years (up to 15 years) for the battery. The range of the transceiver can be augmented by the use of field antennas.

A microprocessor such as an MCU (micro controller unit) controls the operation of the control unit, and actuates the motor valve. The microprocessor is preferably, but not necessarily, an embedded MCU. The MCU is operatively connected to the motor valve. The MCU is preferably bundled with the RuBee® transceiver and a small onboard memory.

Memory. A small memory may be included to store data such as the start and stop times for the timers. The memory also stores a unique identifier for the control unit. This identifier is necessary when a program unit (shown in FIG. 3) is used to control more than one faucet unit.

In one embodiment, a timer may be enclosed within the control unit in order to set the start and stop times for water flow.

An energy source may be a battery (e.g., battery, solar cell, induction coil/rectifier) operable to energize the motor valve and the MCU. The battery is preferably a lithium (Li) CR2525 battery approximately the size of an American quarter-dollar with a five to fifteen year life and up to three million read/writes. Note that only one example of an energy source is shown. The control unit is not limited to any particular source of energy; the only requirement is that the energy source is small in size, lightweight, and operable for powering the electrical components.

### METHOD EMBODIMENTS

Referring to FIG. 5 there is shown one configuration wherein an embodiment of the present invention may be advantageously used. FIG. 5 shows five faucet control units in different locations. In this embodiment, a portable handheld unit is used to program and read/write to the control units. The handheld unit may be used initially to set up the initial programming of the units and then it can subsequently be used to monitor the units and to alter their programming. For example, start/stop watering times can be changed. This can be done because the RuBee® transceiver tags are programmable. The handheld can also be used to read data stored in the control unit's memory, such as calculated water flow. A program unit such as a laptop may be used to read, write and program an unlimited number of control units. The unit is taken to within a foot of control unit and can open all functions.

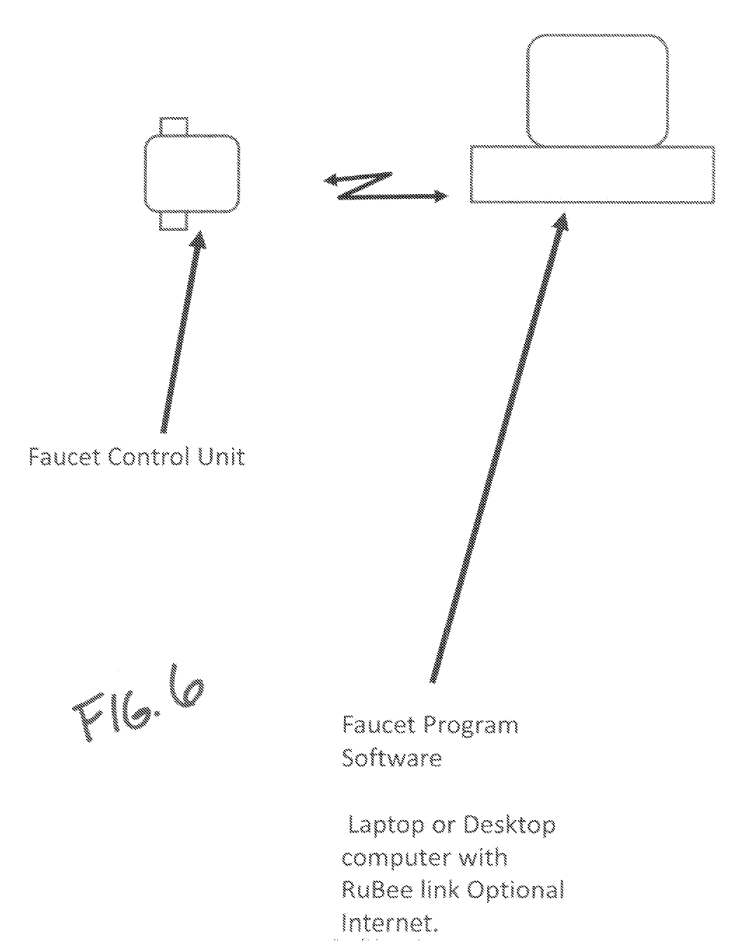

FIG. 6 shows another embodiment wherein the control unit is initially programmed by a laptop, desktop, or other computing unit with appropriate software. After the initial programming, the laptop or desktop may be used to alter the programming and perform reads/writes to the control unit. The RuBee® transceiver can be programmed remotely and wirelessly, provided the range of the antenna is adequate. As stated earlier, field antennas and base stations can be used to augment the range of the onboard loop antenna.

Therefore, while there have been described what are presently considered to be the preferred embodiments, it will understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above.

We claim:

1. A control system for an outdoor faucet, the control system comprising:
a control unit encased in a waterproof housing comprising a substantially rectangular shape with first and second apertures located at opposite ends of the housing; and
wherein the waterproof housing comprises:
an omni-directional antenna;
a transceiver operatively coupled with the antenna, the transceiver operating at a low frequency below 300 kHz and operable to transmit and receive long wavelength packet-based signals through the antenna for programming and monitoring the control unit;
an onboard memory for storing data;
a motor valve for controlling liquid flow;
a micro controller unit operatively coupled with the onboard memory, the micro controller unit configured for controlling operation of the control unit and for actuating the motor valve, wherein the micro controller is operatively coupled with the motor valve; and
a connector for coupling with an energy source for powering the control unit.

2. The control system of claim 1 further comprising:
a liquid inlet inserted through the first aperture and coupled with the motor valve at a first end of the inlet and wherein a second end of the inlet partially extends outside of the waterproof housing for connecting to a liquid source; and
a liquid outlet inserted through the second aperture coupled with the motor valve at a first end of the outlet and wherein a second end of the outlet partially extends outside of an opposite side of the waterproof housing.

3. The control system of claim 1 further comprising the energy source.

4. The control system of claim 1 wherein the omni-directional antenna is a small gauge wire loop antenna wrapped around an inside edge of the waterproof housing.

5. The control system of claim 1 wherein the housing comprises a rounded rectangular shape.

6. The control system of claim 1 wherein the onboard memory comprises program code for enabling the micro controller unit to actuate the motor valve.

7. The control system of claim 6 wherein the program code is modified to change operation of the control unit.

8. The control system of claim 7 wherein the program code is modified to change start and stop times of a liquid flow timer.

9. The control system of claim 1 wherein the transceiver is operable to receive signals continuously.

10. The control system of claim 1 further comprising a liquid flow timer disposed within the waterproof housing.

11. The control system of claim 10 wherein the onboard memory stores data comprising start and stop times for the liquid flow timer.

12. The control system of claim 6 wherein the onboard memory stores calculated liquid flow.

13. The control system of claim 1 further comprising:
a program unit comprising:
program code for monitoring of the control unit; and
a program unit transceiver operable at a same low radio frequency as the control unit transceiver for wireless transmission of the program code to the control unit.

14. The control system of claim 13 wherein the program unit sets up initial programming of the control unit.

15. The control system of claim 13 wherein the program unit is embodied as a portable handheld device.

16. The control system of claim 15 wherein the portable handheld device further comprises a display screen.

17. The control system of claim 1 further comprising a field antenna for extending range of the control unit antenna.

18. The control system of claim 13 wherein the program unit is operable to wirelessly interact with more than one control unit.
